(19) United States
(12) Patent Application Publication
(10) Pub. No.: US 2009/0179024 A1
(43) Pub. Date: Jul. 16, 2009

(54) GROUNDED CRYSTALLINE HEATING RIBBON

(76) Inventor: Ruben Horacio Pryluk, St. Modi (IL)

Correspondence Address: NIXON & VANDERHYE, PC, 901 NORTH GLEBE ROAD, 11TH FLOOR, ARLINGTON, VA, 22203, US

(21) Appl. No.: 12/263,897

(22) Filed: Nov. 3, 2008

Related U.S. Application Data
(63) Continuation of application No. 11/886,221, now abandoned.
(60) Provisional application No. 60/661,512, filed on Mar. 15, 2005.

(51) Int. Cl. F23Q 7/22; B32B 37/02

(52) U.S. Cl. 219/270; 156/47

(57) ABSTRACT

The present invention is directed to a heating ribbon comprising a thin elongated electrically resistive sheet made from a crystalline metal alloy surrounded by at least two electrically insulating layers, wherein the heating ribbon further comprises internal ground means in the form of an electrically conducting foil which is interposed between said insulating layers.

This application is a continuation of U.S. application Ser. No. 11/886,221 filed Sep. 13, 2007 which is a U.S. national phase of International Application No. PCT/IL2006/000339, filed Mar. 15, 2006, which designated the U.S. and claims priority to U.S. Provisional Application No. 60/661,512, filed Mar. 15, 2005, the entire contents of each of which are hereby incorporated by reference.

### FIELD OF THE INVENTION

The present invention relates to crystalline heating ribbons and to method of production thereof. More particularly, the invention relates to a grounded crystalline heating ribbon for indoor and outdoor use, to a method for its production, and for its use in heating, drying, and deicing.

### BACKGROUND OF THE INVENTION

The heating ribbon mat made of amorphous metal which is currently in use for heating purposes, needs an external ground to meet the electricity safety regulations in each country. Moreover, the amorphous metal used in such ribbons is a hard and brittle material and for thicknesses above 28 microns the amorphous metal starts to crystallize. The crystallization of the amorphous metal results in the formation of holes in the metal layer of the heating ribbon which results in a brittle ribbon having a non-uniform electrical resistance. Therefore amorphous ribbons can be manufactured with a thickness of up to 28 microns.

This limitation of the amorphous ribbons is a significant drawback in the area of heating. The amorphous ribbons manufactured nowadays are not suitable for providing coverage of wide areas since their surface area is limited due to the aforementioned thickness limitation.

The electric heating device described in U.S. Pat. No. 6,353,707 includes a flexible resistor ribbon, a plurality of sections of electroconductive coating attached to the resistor ribbon at preset intervals, and connector contacts coupled to the resistor ribbon for enabling connection of a power source to the resistor ribbon. The flexible resistor ribbon is attached to a rigid or flexible flat base panel for incorporation into a building as a floor, wall or ceiling panel.

US 2004/175164 describes an electrical heating device comprising an insulating rigid or flexible shell, and a flexible electric heating element including a flat continuous heating resistance ribbon, disposed inside the shell.

WO 03/037037 describes a heating device comprising a flexible heating element containing a thin, high resistance ribbon arranged between layers of fiberglass mat or mesh, forming heating inserts which are incorporated into a plastic profile during a continuous pultrusion process.

The heating ribbons of the prior art do not provide satisfactory solutions to the aforementioned problems. Therefore there is a need for an electrically grounded crystalline heating ribbon that overcomes the above-mentioned problems.

It is therefore an object of the present invention to provide a grounded crystalline heating ribbon and a method for its production.

It is a further object of the present invention to provide a crystalline heating ribbon that is relatively thick and not easily breakable such that it can cover wide areas and can be flipped and twisted without breaking.

### SUMMARY OF THE INVENTION

The present invention is generally directed to a heating ribbon which is flexible and bendable, and designed to provide emission of relatively high heat power through substantially large surface areas, wherein said heating ribbon comprises a relatively thin resistive sheet made from a crystalline metal alloy which is coated by one or more layers of insulating jacket for sealing and electrically insulating the resistive sheet contained therein, wherein the jacket enclosing the resistive sheet is preferably, partially or entirely, covered by an electrically conducting foil to which a conducting wire may be attached for providing electrical connection therewith, and wherein the conducting foil is covered by one or more layers of an insulating material.

Preferably the crystalline alloy comprises Chromium, Nickel, and stabilizers, wherein said stabilizers may be, but are not limited to, Aluminum, Manganese or Silicon, or combinations thereof. Most preferably, the crystalline alloy comprises 19.9% Chromium, 5.1% Manganese, 3.0% Aluminum, 1.1% Silicon, and 70.9% Nickel. Preferably, the electrically conducting foil is an Aluminum foil.

The present invention is also directed to a heating element comprising a flexible and foldable heating ribbon having a substantially large surface area (for example having width of about 30 mm), wherein said heating element comprises a substrate on which said heating ribbon is mounted, preferably by bending portions thereof into a flat zigzagged form. The heating ribbon may be attached to the substrate by a type of adhesive tape. Conveniently, conducting wires are electrically connected at each end of the heating ribbon to the resistive sheet contained therein for connecting it to a power source. The conductive foil of the heating ribbon may be connected to the electrical ground of the electricity network.

The present invention is also directed to a method for producing a flexible and bendable heating ribbori, comprising extruding a thin elongated resistive sheet from a crystalline metallic alloy, coating the elongated resistive sheet by an insulating jacket, covering, partially or entirely, the coated elongated resistive sheet with a conductive foil, to which a conducting wire may be electrically attached, and enclosing the coated resistive sheet and the conductive foil covering it within one or more insulating layers.

### BRIEF DESCRIPTION OF THE DRAWINGS

The present invention is illustrated by way of example in the accompanying drawings, in which similar references consistently indicate similar elements and in which:

FIG. 1 is a cross-sectional view of the heating ribbon of the invention; and

FIG. 2 illustrates a heating element arrangement of the invention.

### DETAILED DESCRIPTION OF PREFERRED EMBODIMENTS

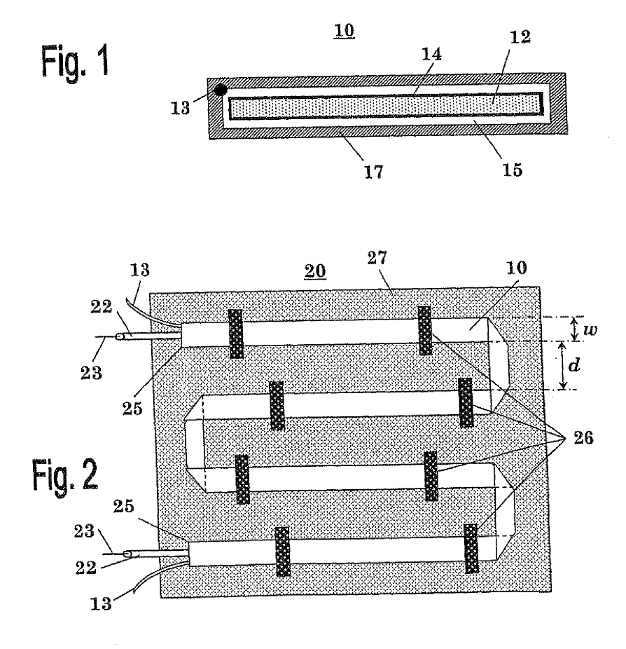

The present invention provides a heating ribbon and heating elements comprising a resistive sheet (12 in FIG. 1) made of a Nickel-Chromium based alloy having high electrical resistivity (e.g., 1.1-4.2 ohm/meter). The heating ribbon of the invention is preferably coated with double or triple polyethylene insulation layers (jacket 14) applied by a co-extrusion process.

A cross sectional view of the heating ribbon 10 of the invention is shown in FIG. 1. Heating ribbon 10 comprises a resistive sheet 12 which is used as the heating element of heating ribbon 10. Resistive sheet 12 is preferably coated with jacket 14 for electrically insulating it. Jacket 14 may be covered by an electrical conductive foil 15 to which a conductive wire 13 may be electrically connected for providing the required external grounding contact. This arrangement may be coated with an insulating layer 17 enclosing the above mentioned resistive sheet 12 and its jacket 14, the conducting foil 15 and wire 13.

Resistive sheet 12 may be manufactured by a co-extrusion process from a crystalline metallic alloy having suitable electrical conductivity. The thickness of the extruded resistive sheet 12 is generally in the range of 10 microns (micro-meter) to 50 microns, preferably about 30 microns, and its (cross-sectional) width is generally in the range of 7 to 45 mm, preferably about 25 mm. The length of resistive sheet 12 may vary depending on the requirements of each specific application. For example, in under floor heating the length of the heating ribbon may generally be in the range of 60 to 80 meter, preferably about 62 meter.

The crystalline metallic alloy used in the manufacturing of resistive sheet 12 may be made from any suitable compound or alloy having high electrical resistivity. Preferably said crystalline metallic alloy is composed of Chromium, Nickel, and stabilizers, and may have a conductivity of about 1.37 ohm-cm². For example, the crystalline metallic alloy may be manufactured using 17-22% Chromium, 70-75% Nickel, and small amounts of stabilizers.

Various stabilizers may be used in the preparation of said crystalline metallic alloy, however, Aluminum, Manganese and Silicon, are preferable due to the improved flexibility and strength of the metallic ribbon provided therewith. The weight percentage concentration in the alloy of said stabilizers may generally be in the range of 2.5-3.5% Aluminum, 4-6% Manganese, and 0.9-1.5% Silicon. For example, said crystalline metallic alloy may be comprised of 19.9% Chromium, 5.1% Manganese, 3.0% Aluminum, 1.1% Silicon, and 70.9% Nickel.

The jacket 14 of the resistive sheet 12 is preferably applied according to the Teldor specification “719HTNN doubled coating for crystalline metallic ribbons”. Jacket 14 may be comprised of polyethylene, preferably, it is made of PO having thickness of about 0.25 mm, such as used for jacketing of power and communication cables. The jacket 14 preferably has the following characteristics:
High melting temperature (approximately 120° C.);
Low coefficient of friction (satisfying UL 1581/1040 standard UL 1581/460);
satisfying the UL1581/593 cold impact requirements;
satisfying the flame resistant UL 94HB standard;
Low water absorption (satisfying UL 1581/1040 standard);
Contains a well-dispersed, highly effective UV-stabilizer in sufficient amount to ensure excellent weathering resistance.

The extrusion window used for applying jacket 14 is preferably a relatively wide processing window (e.g., 27×555 microns), allowing the coating material to flow and cover resistive sheet 12 with a constant thickness and at a rate of about 40 to 60 meter/minute.

The thickness of jacket 14 may generally be a in the range of 400 to 600 microns, preferably about 500 microns, and it is preferably arranged such that it surrounds the resistive sheet 12. Jacket 14 may comprise an additional coating layer, applied in a similar manner to the first layer, the thickness of which may generally be in the range of 400 to 600 microns, preferably 400 microns.

Conducting foil 15 may be manufactured from a flexible and electrically conducting material, preferably from Aluminum. Most preferably, conducting foil 15 is a polyester Aluminum foil tape wrap providing 100% coverage laid in a close contact with a 7×0.16 mm, 26awg, TC-drain-wire. The geometrical dimensions of the conducting foil 15 and of the conductive wire 13 are preferably calculated according to the thickness and width of the resistive sheet 12, in order to assure that the maximal allowed current conditions according to the safety regulations for the ground requirements are satisfied. More particularly, the thickness of conductive wire 13 should be at least 1.15 times thicker than the total thickness of the conducting foil 15.

Accordingly, the general thickness of the double layered jacket 14 may be in the range of 1000 to 1400 microns (including the aluminum metal).

After completing the coating process (extruded polyethylene layers 14) the conducting foil 15 is added to the heating ribbon 10 via a co-extrusion process which preserves the flexibility of the ribbon 10. The coated ribbon is covered by the conducting foil 15, and conducting wire 13 is electrically attached to it, which are then coated with the final insulation (polyethylene) layer 17 that is preferably also applied by an extrusion process.

The conductive wire 13 is preferably a threaded wire made of copper, or other conducting material having suitable flexibility. For example, conductive wire 13 may be a 7×0.16 mm or 25×0.16 mm wire. Conductive wire 13 is preferably located at one of the lateral sides of the heating ribbon 10, in electrical connection with the conducting foil 15 and it is drawn along the entire length of the heating ribbon 10.

A general structure of a heating element 20 of the invention is shown in FIG. 2. Heating element 20 comprises a heating ribbon 10 folded and mounted onto substrate 27. Substrate 27 may be manufactured from a flexible and electrically insulating material, preferably from fiberglass. For example, substrate 27 may be prepared from a fiberglass net having a nominal specific density of about 120 grams per 1 square meter, and having a nominal hole size of about 10×10 mm. Substrate 27 also serves as a shaper used to establish the structure desired for heating element 20.

Heating element 20 may be configured in a variety of ways according to the desired heating power. Heating ribbon 10 is preferably placed on the surface of the substrate 27 in a manner that leaves a rim of about 2-3 cm from each side of substrate 27.

The density of the heating element 20 is defined by the ratio between the area of the substrate 27 in which the heating ribbon 10 resides and the total area of the substrate 27. For example, in under floor heating applications, a ribbon density of 50% means that 50% of the floor area is covered by the heating ribbon 10. It should be noted that such coverage is not possible with the conventional heating cables such as used in these applications since the heating cable has a circular cross-sectional area, and since the heating produced by the heating ribbon 10 of the present invention is evenly emitted from the surface of the ribbon. While the allowed nominal ribbon density range is between 27% to 50%, heating element 20 may be designed to provide a nominal ribbon density of 30%.

The length of substrate 27 may generally be in the range of 2 to 12 meter, and its width may be about 50 mm. The length of heating ribbon 10 mounted on substrate 27 is generally in the range of 50 to 90 meter, preferably about 65 meter. Of course, heating element 20 may be manufactured and supplied without the substrate 27.

Heating element 20 may be connected electrically to a power source via wires 23. The connectors connecting wires 23 to the resistive sheet 12 are preferably a tin coated thin iron based connectors with contacts pressed and attached to the resistive sheet 12 at each end 25 of heating ribbon 10. Wires 23 may be copper based twisted electrical wires having a diameter of about 2 mm. Most preferably, wires 23 are of a type that meets IEC22.8 class 5 requirements, and having a double layered insulation made of PVC (having 105° c. heat durability). The nominal diameter of each wire 23 is preferably about 3.3 mm, and generally, their diameters will not exceed 3.4 mm. Wires 23 preferably meet UL1015 requirements, and they generally have a length of about at least 3 meters.

A shrinking sleeve 22 encloses and seals each of the wires 23, in particular the connection between the resistive sheet 12 and the “cold” electrical wires 23 (i.e., serving as electrical contacts between the power source and the heating ribbon 10 but which do not transfer Heat). The sleeve 22 preferably has a shrinking ratio of 1 to 4, e.g., ATUM series, and temperature stability in the range of −55° c. to 110° c. The shrinking sleeve 22 preferably meets the MIL-DTL-23053/4, class 3 (military standard specification approval for safety water immersion resistance), and Raychem specification RK-6025.

Adhesive tape 26 is used to affix heating ribbon 10 to the carrying substrate 27 and thus it simplifies the installation of heating ribbon 10. Adhesive tape 26 is preferably a

Polypropylene adhesive tape, such as defined by Israeli standard 791, with the following characteristics:

Width: 47 microns

Tensile strength: 100N to 25 mm.

Lengthening: 130%.

Adhesive strength: 12N to 25 mm.

Storage life: 1 year.

Polypropylene sheet temperature limit: 120° c.

The outputted power of each heating element 20 is preferably rated according to the CEI IEC 60335-1 international standard for heating appliances, paragraph 10.

As a consequence the measured resistance tolerance is the reciprocal of the power deviation. It should be noted that the nominal rated power can also vary from the 100, 120, 150, 200, 300, 400, 500 watt values according to the geometrical dimensions of the heating element 20 and the length of the heating ribbon 10 that is placed on substrate 27.

### Example

For a heating element 20 of about 2.25 sqm (e.g., 450×50 cm) a heating ribbon 10 of about 10 cm wide (w) and 50 micron thickness may be used. In such embodiment a heating ribbon 10 of about 150 watt/sqm is obtained for an operating voltage of 230 volts, such that the total power of the heating element 20 is about 337.5 watts for a heating ribbon 10 with a total length of approximately 58.4 meters. The distance (d) between the portions of the flipped ribbon are preferably about 3.8 cm. The conducting foil 15 that cover the resistive sheet 12 is preferably of about 12 micron thickness and the diameter of the conductive wire 13 is preferably about 0.50 mm and its resistance is approximately 0.33 ohm/meter. In this preferred embodiment the total resistance of the ribbon is about 2.8 ohm/meter and the density of heating element 20 is about 32%.

All of the abovementioned parameters are given by way of example only, and may be changed in accordance with the differing requirements of the various embodiments of the present invention. Thus, the abovementioned parameters should not be construed as limiting the scope of the present invention in any way. In addition, it is to be appreciated that the different sheets, foils, coating, and other members, described hereinabove may be constructed in different shapes (e.g. having oval, square etc. form in plan view) and sizes differing from those exemplified in the preceding description.

The above example and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

### Detailed Description of the Invention

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A heating ribbon comprising a thin elongated electrically resistive sheet made from a crystalline metal alloy surrounded by at least two electrically insulating layers, wherein said heating ribbon further comprises internal ground means in the form of an electrically conducting foil which is interposed between said insulating layers.

2. The heating ribbon according to claim 1, wherein a conducting wire is attached to the conducting foil for providing electrical connection thereto.

3. The heating ribbon according to claim 1, wherein the crystalline alloy comprises Chromium, Nickel, and one or more stabilizers.

4. The heating ribbon according to claim 3, wherein the one or more stabilizers are selected from the group consisting of Aluminum, Manganese and Silicon.

5. The heating ribbon according to claim 4, wherein the crystalline alloy comprises 19.9% Chromium, 5.1% Manganese, 3.0% Aluminum, 1.1% Silicon, and 70.9% Nickel.

6. The heating ribbon according to claim 1, wherein the electrically conducting foil is an Aluminum foil.

7. A heating element comprising a flexible and foldable heating ribbon mounted on a substrate by bending portions thereof into a flat zigzagged form, wherein the heating ribbon comprises a relatively thin elongated resistive sheet made from a crystalline metal alloy and an electrically conducting foil, partially or entirely, covering said resistive sheet, and wherein one or more layers of the insulating jacket isolates said elongated resistive sheet and said conducting foil.

8. The heating element according to claim 7, wherein the heating ribbon is attached to the substrate by an adhesive tape.

9. The heating element according to claim 7, wherein # conducting wires are electrically connected at each end of the heating ribbon to the elongated resistive sheet contained therein.

10. The heating element according to claim 7, wherein the crystalline alloy comprises Chromium, Nickel, and one or more stabilizers.

11. The heating element according to claim 10, wherein the one or more stabilizers are selected from the group consisting of Aluminum, Manganese and Silicon.

12. The heating element according to claim 11, wherein the crystalline alloy comprises 19.9% Chromium, 5.1% Manganese, 3.0% Aluminum, 1.1% Silicon, and 70.9% Nickel.

13. A method for producing a flexible and bendable heating ribbon, comprising extruding a relatively thin elongated resistive sheet from a crystalline metallic alloy, coating said elongated resistive sheet by one or more layers of insulating jacket, partially or entirely covering the coated elongated resistive sheet with a conductive foil, and enclosing said coated resistive sheet and said conductive foil with an insulating layer.

14. A method according to claim 13, further comprising attaching a conducting wire to the conducting foil.

15. A method according to claim 13, wherein the crystalline alloy comprises Chromium, Nickel, and one or more stabilizers.

16. A method according to claim 15, wherein the one or more stabilizers are selected from the group consisting of Aluminum, Manganese and Silicon.

17. A method according to claim 16, wherein the crystalline alloy comprises 19.9% Chromium, 5.1% Manganese, 3.0% Aluminum, 1.1% Silicon, and 70.9% Nickel.
